(19) United States
(12) Patent Application Publication
(10) Pub. No.: US 2017/0109150 A1
(43) Pub. Date: Apr. 20, 2017

(54) DATA COMPACTION

(71) Applicant: C24 Technologies Limited, London (GB)

(72) Inventor: John Terrell Davies, London (GB)

(21) Appl. No.: 15/317,820

(22) PCT Filed: Jun. 11, 2015
(86) PCT No.: PCT/GB2015/051725

§ 371 Date: Dec. 9, 2016

(30) Foreign Application Priority Data
Jun. 11, 2014 (GB) 1410402.0

(51) Int. Cl. G06F 9/45

(52) U.S. Cl. CPC G06F 8/51

(57) ABSTRACT

Method and system for arranging data comprising receiving a data set including one or more data elements. Generating from an indication of properties of the one or more data elements an arrangement scheme describing how to arrange the data elements. Arranging the data elements according to the arrangement scheme. Generating a set of computer readable procedures for returning the data elements from the arranged data elements.

### FIELD OF THE INVENTION

This invention relates to the field of improving the efficiency of computers, and more especially to the subject of efficiently storing, serialising, compacting and structured data.

### BACKGROUND OF THE INVENTION

Data is commonly held in and exchanged between modern computer application systems in relatively verbose, structured forms that are often designed to be more or less human-readable. Extensible Markup Language (XML) and JSON are examples of this, and there are many others both standardised and proprietary. Where such data is required to be parsed into computer memory and either manipulated, stored or transmitted to other systems, so-called binding techniques are often used in software to convert the raw data into a memory representation for the CPU. Existing binding techniques and tools (for example, JAXB, JiBX and Castor) tend to be inefficient in terms of memory use, creating in-memory representations that are often many times greater in size than the original data in its native format. By contrast, existing compression techniques, while providing greater memory efficiency, require a de-compression step before data in-memory can be interrogated or navigated, and so adversely impact overall system performance by introducing additional processing overhead.

For example, JAXB uses a binding definition document to specify how Java data objects are converted to and from XML. In other words, JAXB requires the binding definition document to state how individual elements of XML are to be converted into Java class objects and vice versa. This can apply to any current computer language including JVM specification languages such as Scala and Groovy, .NET framework languages and others.

Binding tools will typically create an entity definition for each sub-structure (or ‘type’) within the document. A bound document therefore will typically create in memory a tree of instances of these types (‘objects’) to represent the document's structure and content. Each of these objects could be allocated anywhere in memory and, in addition to its own data, will need to hold a reference to all of its child objects.

Therefore, there is required a system and method that uses memory more efficiently whilst retaining the ability to navigate and retrieve data effectively and with full granularity.

### SUMMARY OF THE INVENTION

This invention is concerned with software techniques that result in more efficient data compaction that also preserves the ability to navigate and query with full granularity. It also presents an advantage for data serialisation due to the fact that the in-memory representation may be identical to the serialised representation. More efficient storage allows CPU architectures to take further advantage of local cache (L1, L2 & L3) loading. This is achieved by holding the data for each element in a structure in a way that it can be more efficiently accessed, without recourse to expensive decompression techniques or the need to decompress earlier fields in order to be able to interpret subsequent ones.

Data may be received together with an indication or description of properties of the data, data fields or elements. For example, the data description (e.g. a data model or schema) may indicate that a particular data field can only contain one of a predetermined set of values. The indication or description of properties of the data may be received together with or separate from the data itself. In some implementations, the properties of the data may already be available or stored locally and so does not need to be received. The indication of properties or data object definition may be a standard or protocol definition of a particular data schema, for example. Data may be analysed (if available) to search for commonly used values to provide further information about the data.

From the data description, a storage strategy, arrangement scheme, codec and/or model is produced. This describes how the data is to be arranged or represented and is derived based on the information in the data model. The data elements are then arranged or stored according to the arrangement scheme. Furthermore, a set of procedures, or a set of getters may be generated that may be used to read, return, recover or retrieve the data elements whenever they are required or requested. Typically, the data may be arranged as bits or bytes, with little or no structure. The getters calculate any required offset at runtime, access the relevant bits/bytes and interpret them in order to return the data in the required form.

Data binding software techniques are provided that result in highly efficient data compaction whilst preserving full granularity of querying and navigation of the original data structure. Memory consumption and other computing resources (e.g. communications bandwidth) may be reduced allowing very large volumes of data to be managed without loss of granular detail in accessing and querying the data. Compute-intensive de-compression may be avoided meaning that system performance generally remains uncompromised, and in many cases is significantly enhanced. Particular gains may be as a result of better CPU cache hits and reduced complexity of serialisation and/or deserialization.

The system and method may be implemented using a software process for binding data in native (or wire) format to provide enhanced efficiency in-memory, persisted and network-transmittable representations.

Instead of attempting to create an entire detailed object graph in memory (as used in prior art techniques), the raw data may be persisted, stored or communicated in a simple array of bits or bytes (for example as a byte array in a Java language implementation). This has an advantage that for native binary data formats, it reduces or eliminates the need to parse the data altogether as the raw structure may be read directly.

A further feature of the process is the automatic generation of an accessor and/or setter API (Application Programming Interface) or other set of procedures, over the data based on the indication or properties (e.g. a metadata model) that describes its structure. This template has knowledge of the metadata model, and therefore can calculate where in the array of bits or bytes to find any given piece of information. There is no need to store any metadata in the data stream or in-memory instance as everything may be contained in the bound API.

An advantage of this is that the user of the software has access to the same interrogation and navigation code that they are accustomed to using in the context of traditional binding tools, said API being optionally capable of conforming to existing APIs for accessing the same data structure—thus the API becomes consistent regardless of the in-memory representation of the data.

A further advantage is that because data retrieval is ‘lazy’, meaning calculated on-the-fly rather than by storing parsed values, the memory required may be essentially just that of the raw data, resulting in a lower memory footprint compared to that obtained using existing techniques.

Yet another advantage is that once data is compacted in this fashion, efficiency of transmission across the network may be considerably increased.

Another advantage is that when using the compacted binary for persistent storage, the smaller memory footprint results in more efficient use of storage media and faster read/write times.

Any data created “on-the-fly” such as an Object required in the API may be generated “on-the-fly” and therefore use more efficient “young memory” in the JVM (Eden space).

Another advantage is that unlike traditionally persisted formats, the compacted data is immediately “understandable” by the CPU, and does not necessarily need to be parsed, unmarshalled or decompressed. The in-memory representation of the data is more efficient when contiguous, i.e. with it all in the same byte array where the entire section of memory can be written to the network or device (disk/SSD etc.) without conversion or processing. Therefore, processing can often be performed without (or with less) CPU intervention (i.e. DMA). This may further save CPU resources. The reverse is true for deserialisation into memory. As a consequence, memory to serialised format and back to memory may be performed efficiently.

The code generation step in the process makes use of the metadata model to inform a code generator about efficiencies and savings that are possible in the persisted or communicated structure. For example, if the metadata model (or other indication of properties of the data) defines a particular data field as restricted in value to a certain list of enumerated values, only bit values representing members of the allowable list need be arranged or stored as opposed to the full, verbose values.

In accordance with a first aspect there is provided a method for arranging data comprising the steps of:

receiving a data set including one or more data elements;

generating from an indication of properties of the one or more data elements an arrangement scheme, protocol or codec describing how to arrange the data elements;

arranging or representing the data elements according to the arrangement scheme; and

generating a set of computer readable procedures for returning the data elements from the arranged data elements. Therefore, data may be arranged or in some embodiments stored, transmitted or handled more efficiently taking up less space in memory (or any other data storage) or using lower network bandwidth, whilst the computer readable procedures allow the data to be retrieved as conveniently as if it were arranged according to software binding. The indication of properties of the data elements may be received before, after or with the data elements or be stored locally or form an expected format or standard of the data. The computer readable procedures may be generated each time the properties of data change. Otherwise, existing procedures may be reused.

Preferably, the indication of properties may be a data model or schema. For example, this may be an XML or JSON schema.

Preferably, the data model or schema describes the format and/or structure of the data set. It may also include information necessary to create a lookup or static table of alternative data element values, for example.

Optionally, the method may further comprise the step of storing the arranged data elements. The data may be stored in transient or volatile memory or stored in persistent memory (e.g. on disk, in FLASH memory or within an SSD, for example). The arranged or reformatted data elements may also be transmitted (for example, over a network). The storage or transmission may be at the wire level.

Advantageously, the data may be stored as an array. This may be in the memory (any type including persistent a volatile). This array may take different forms, including a byte array, for example.

Optionally, the array may be an array of bits or bytes.

Optionally, the memory may be persistent or volatile memory. For example, this may be RAM, SSD, HDD, FLASH, etc. The data may be cached in memory.

Preferably, the step of generating the arrangement scheme includes the step of determining a data allocation requirement for the data elements based on the indication of properties. Determining the storage requirement may include allocating the maximum memory requirement for each data type for all possible data elements, for example.

Advantageously, the step of generating the arrangement scheme may further comprise the step of minimising the data allocation or storage requirement for each data element. This may include applying various data management rules or schemes, for example.

Optionally, the computer readable procedures may define one or more enumerated values associated with the one or more data elements and wherein the associated data elements are returned in response to enumerated values. In other words, rather than arranging, storing or transmitting data elements in the form that they are received (or provided as an input), if the possible values for a particular data field are limited (i.e. more restricted than the number available for a particular data type) then instead of including the data elements themselves, a key, hash, enumerator or parameter that refers to one of the possible values is retained or used. This further reduces the memory space and bandwidth required. This can be done at the field level or message level, i.e. a field can contain hashed values relating only to the field or it can contain a hashed value that refers to a global field possibly re-used across the entire message.

Preferably, the computer readable procedures may provide instructions for retrieving or returning the data elements (e.g. from the memory).

Optionally, the data elements may be elements of XML or UML. Other formats may be used. This may include other mark-up languages, file formats, declarative languages, binary values, such as CSVs, JSON, etc.

Optionally, the computer readable procedures may be compiled code. These may be compiled when the indication of data properties are received or at another time.

Advantageously, the set of computer readable procedures may be in the form of an application programming interface, API. Other forms may be used.

According to a second aspect, there is provided a method for returning data comprising the steps of:

receiving a request to return a data element from an arrangement of data;

selecting a computer readable procedure for returning the data element from a set of computer readable procedures; and
executing the selected computer readable procedure. This method or further aspect may be combined with any aspect of the method for storing, transmitting or arranging the data, described above.

Optionally, the computer readable procedures may be configured to calculate a location of the requested data element within the arrangement of data (for example, those that may be stored in memory, transmitted or otherwise used). This may be done when a request for data is received. This may also extend to setter and setting data.

Automatic “bookmarks” or markers may optimise the calculation of the offset. Therefore, a calculation of the offset from the previous marker may only be required.

Data may also be stored internally in a more efficient format so that commonly read variables are at the beginning of the data array, requiring less calculation.

According to a third aspect, there is provided system for arranging data in comprising:

logic configured to:
receive a data set including one or more data elements;
generate from an indication of properties of the one or more data elements an arrangement scheme describing how to arrange the data elements;
arrange the data elements according to the arrangement scheme; and
generate a set of computer readable procedures for returning the data elements from the arranged data elements; and

a processor configured to execute the logic.

Preferably, the logic may be further configured to:

receive a request to retrieve or return a data element (e.g. from memory or a transmitted stream);

select a computer readable procedure for retrieving or returning the data element from a set of computer readable procedures; and
execute the selected computer readable procedure

The methods described above may be implemented as a computer program comprising program instructions to operate a computer. The computer program may be stored on a computer-readable medium.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operation system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic representation of process steps involved in creating an optimised software code template from a metadata model;

FIG. 2 shows a schematic representation of a process in which the software code template of FIG. 1 is used at runtime;

FIG. 3 shows a flowchart of a method for storing data;

FIG. 4 shows a flowchart of a method for retrieving data the data stored according to the method of FIG. 3;

FIG. 5 shows a schematic diagram of a system for carrying out the methods of FIGS. 1 to 4;

FIG. 6 shows a flowchart of an example implementation of the methods for both storing and retrieving data;

FIG. 7 shows a further example schematic representation of process steps involved in creating an optimised software code template from a metadata model;

FIG. 8 shows a flowchart of a further example method;

FIG. 9 shows a flowchart of a further example method;

FIG. 10 shows a flowchart of a further example method; and

FIG. 11 shows a schematic representation of data stored according to the method of FIG. 6.

It should be noted that the figures are illustrated for simplicity and are not necessarily drawn to scale. Like features are provided with the same reference numerals.

### DETAILED DESCRIPTION OF THE PREFERRED EMBODIMENTS

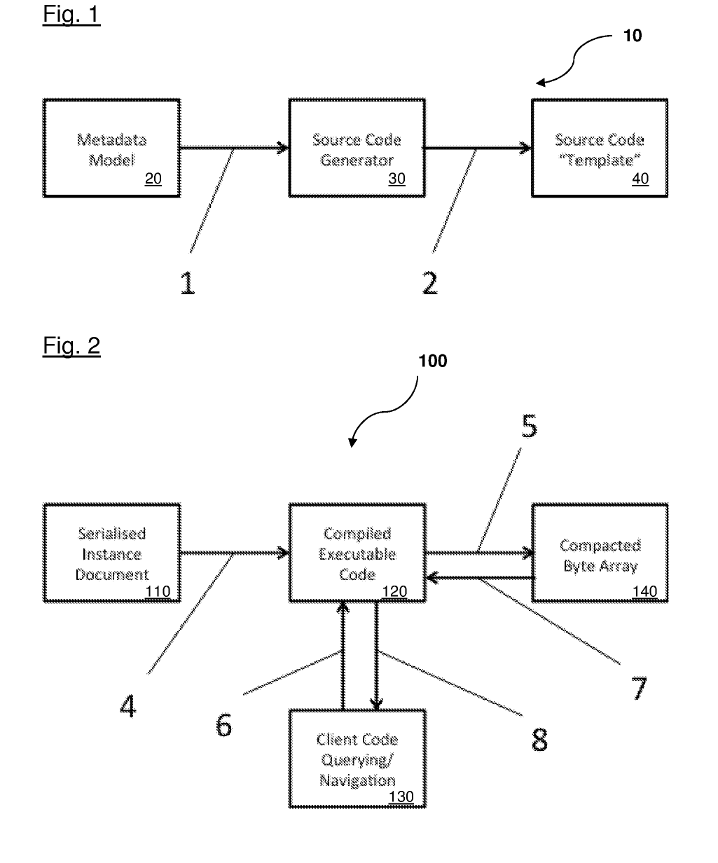

FIG. 1 shows schematically an example process 10 for generating executable software code from a data model (or metadata model) 20 that describes a data structure of interest or concern to a user or application developer. This process is generally known as “binding”, and is an established mechanism used today.

In step (1), the metadata model 20, which may be a machine-readable description of a data structure or properties of those data and the constraints applicable to it, is consumed by a software component 30 that is designed to generate source code based on the model 20. In one implementation, this is enacted using the Java language, but this method is not limited to any particular programming language or platform. Step (1) is where detailed aspects of the structure of the data and the constraints applicable to it are described in such a way as to enable the following step to optimise the structure of the target bit or byte array in which data will be arranged (and then may be stored, persisted, transmitted or otherwise used), and the bound source code template that will interpret it at runtime. The model may be decorated with information such as data types, length constraints, allowable values and the number of occurrences of each type that may occur.

In step (2), data types are examined and decisions made about the most efficient way to store them. In an enumeration example, a data item ‘weekday’ is supplied as a 3-character field of the form ‘MON’, ‘TUE’, ‘WED’ etc. it is clear that there are only ever a maximum of 7 possible values that this data item can take and therefore no more than 3 bits are required to store this information in the byte array (3 bits can store 8 values, only 7 are needed for the days of the week). Therefore, these bits can be compacted together and do not need to be byte-aligned. When all component parts of the data model have been allocated space in the output byte array structure, source code is constructed that can calculate the location of where to find each component part and exposes methods to make the structure easily queried and navigated at runtime, this frequently requires binary masking and shifting.

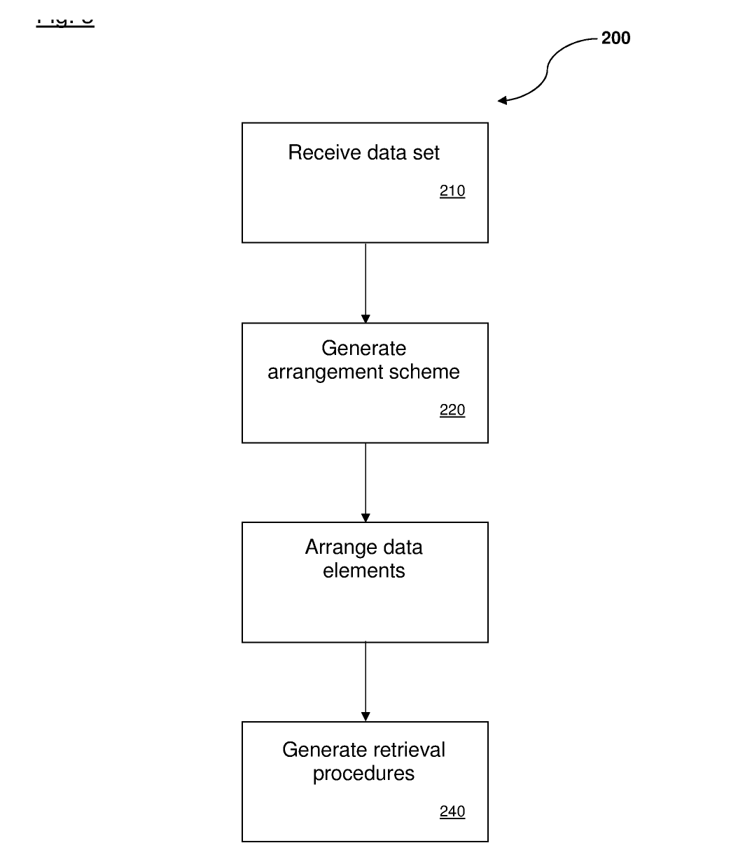

FIG. 2 shows schematically a method 100 that operates at runtime to retrieve or return data that was arranged according to the method of FIG. 1.

In step (4) a serialised instance 110 of the data under consideration is consumed by a compiled instance 120 of the source code generated by the process shown in FIG. 1). This step amounts to parsing the data.

Step (5) represents the population of an array of bytes according to the pre-determined structure now encapsulated in the compiled executable code 120.

In step (6), client code 130 interested in querying or navigating the stored data invokes methods on the compiled executable code 120.

In step (7), the information required is retrieved by the compiled executable code from the relevant parts of the byte array 140, and returned to the client in step (8).

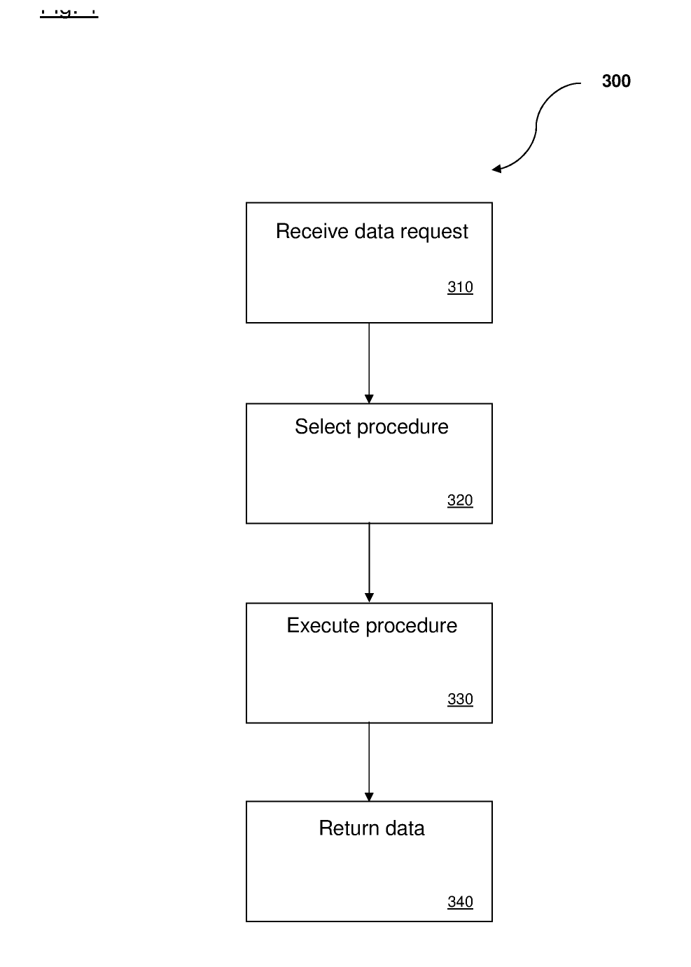

FIG. 3 shows a flowchart of a generalised method 200 for arranging data. At step 210 the data set to be stored are received. These data may be received together with details of properties of that data set or in isolation (the properties of data may be received separately or already be present or available). An arrangements scheme (or storage model) is generated from these data properties at step 220. This takes into account aspects of the data model, including properties of individual data elements.

The data elements are arranged according to the arrangement scheme at step 230. The data elements may be arranged and then allocated to various memory types such as persistent memory, volatile memory, cache memory, databases, files or stored locally or remotely and transmitted over a network. Procedures for retrieving or returning the data elements are generated at step 240. These procedures may describe locations within the memory (or within a transmission stream) to retrieve individual elements that may be arranged without any particular structure.

FIG. 4 describes a generalised method 300 for retrieving or returning data arranged according to method 200. At step 310, a request for data is received. This may be received from a client or other software or hardware component. At step 320, a particular procedure or method is selected based on the requested data. This procedure may be selected from the compiled executable code 120, for example. At step 330, the selected procedure is executed so that one or more data elements are returned or retrieved and the requested data is returned at step 340.

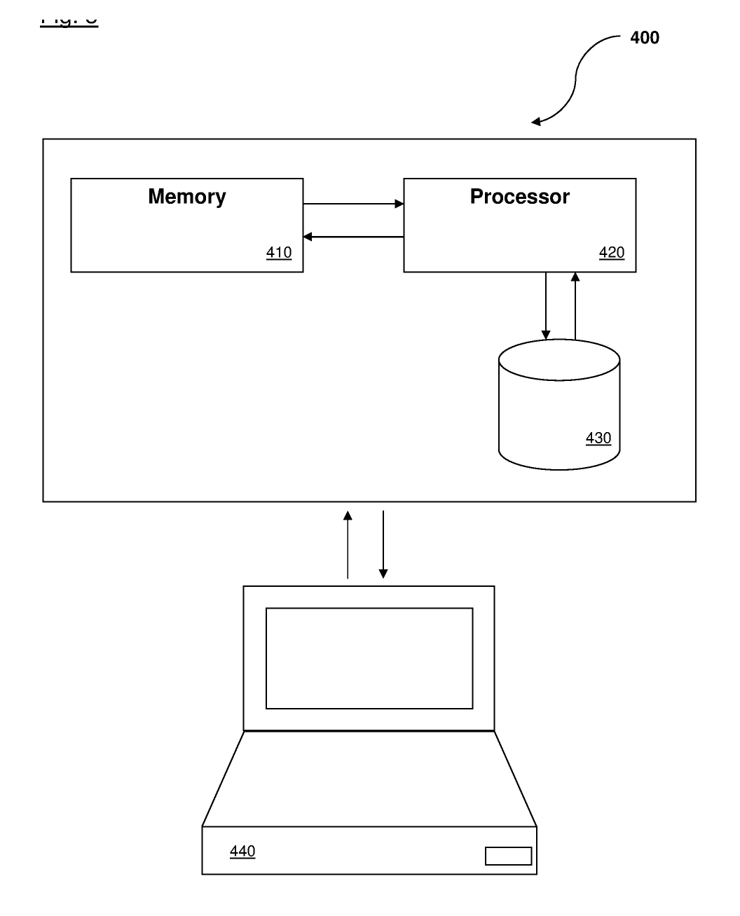

FIG. 5 illustrates schematically a system 400 for implementing the methods 10, 100, 200 and 300 described previously. In a memory storage implementation, the memory 410 used to store the data elements is illustrated in this figure as well as a processor 420 used to execute any of the procedures and method steps described with reference to those methods. A database or data store 430 is used to store generated source code 40 and/or the compiled executable code 120 and any other components required to carry out the methods. The database or data store 430 may be a relational database (e.g. Oracle, Sybase, SQLServer), for example.

A client computer 440 is illustrated in FIG. 5 as the component making requests for data and receiving those requested and returned data elements. A computer system is illustrated in this figure. However, the client 440 may be any requesting entity, agent or component.

The following provides an example of standard Java binding with the following example XML data:

```
<resetFrequency>
  <periodMultiplier>6</periodMultiplier>
  <period>M</period>
</resetFrequency>
```

The binding definition may be defined as:

```
<binding>
  <mapping name=”resetFrequency” class=”ResetFrequency”>
    <value name=”periodMultiplier” field=”periodMultiplier”/>
    <value name=”period” field=”period”/>
  </mapping>
</binding>
```

The Java class may then be defined as:

```
public class ResetFrequency {
  private BigInteger periodMultiplier; // Positive Integer
  private Object period; // Enum of D, W, M, Q, Y
  public BigInteger getPeriodMultiplier( ) {
    return this.periodMultiplier;
  }
  // constructors & other getters and setters
```

Therefore, the XML element periodMultiplier maps to a Biglnteger Java object and period maps to an Object period in the Java class ResetFrequency. The Java class also contains the method getPeriodMultiplier for retrieving the data.

In memory (or within a stream of data), these three objects must be stored or allocated at least 144 bytes: The parent, a positive integer and an enumeration for Period. Three Java objects at 48 bytes results in the use of 144 bytes. Furthermore, this may become fragmented in memory.

Using the present method and system generates a retrieval procedure for the same XML data as:

```
Byte array data; // From the root object
  public BigInteger getPeriodMultiplier( ) {
    int byteOffset = 123; // Actually a lot more complex
    return BigInteger.valueOf( data.get(byteOffset) & 0x1F );
  }
  // constructors & other getters
```

In memory (or within a data stream), this requires one byte for all three fields. The root contains one byte array which is a wrapper for byte[ ]. The getters use bit-fields, Period requires only three bits for values D, W, M, Q or Y.

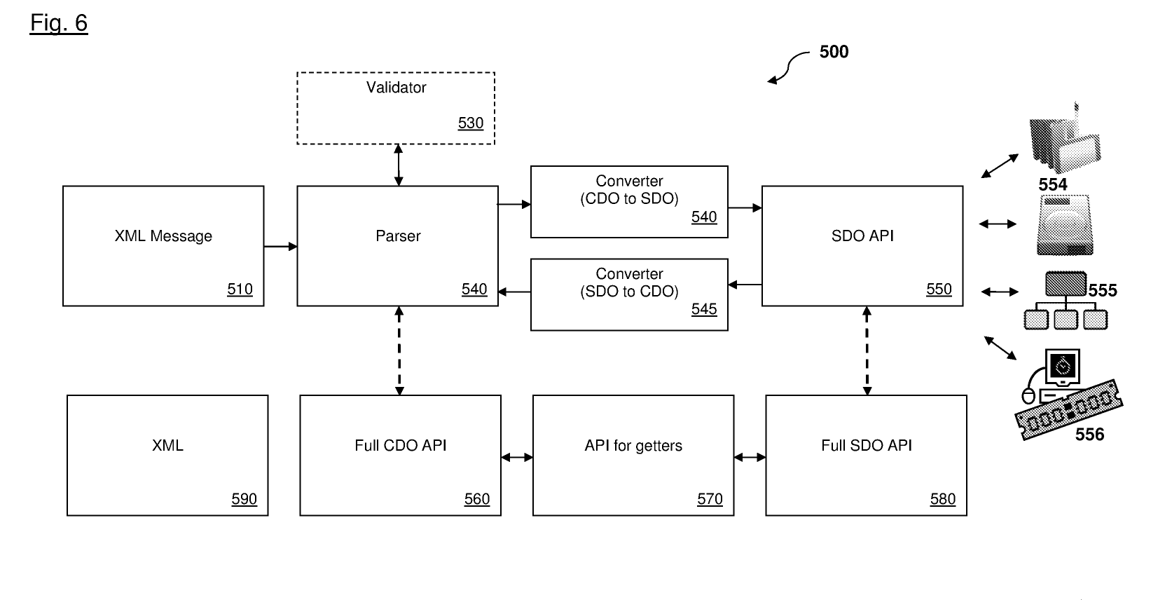

FIG. 6 shows a flow chart of an example method 500 for arranging data. In this example, the data is XML 510 but other data formats or types may be used. This may be provided as an input (i.e. the XML data is to be arranged) or as an output as retrieved, returned, obtained or restored data. Not all of the steps in this procedure are described as essential, especially the validation or parsing steps.

The data (XML 510) may be received and then parsed by the parser 540 in order to process or reformat any data or data elements. The parser 540 may be a Java API, for example. The data may also be validated by the validator 530. For example, the XML 510 and its data elements may be checked to ensure that they conform to one or more standard formats (e.g. FpML) and/or converted as necessary.

When the input is XML and the data is to be arranged for storage or transmission, for example, then the process may be seen to form a simple data object (SDO) or arranged data from a complex data object (CDO), i.e. data to be arranged. Converter 540 (or sink) converts from CDO to SDO and Converter 545 (or source) converts from SDO to CDO. Both of these converters are based on an indication of data properties (in this example an XML schema) to carry out the conversion.

For example, the XML data may include a data element representing a currency amount. The currency amount may be limited to two decimal places. However, the currency amount in the original XML schema may take the form of a string. Therefore, when converting from CDO to SDO, the converter 540 may restrict or convert the data type of this data element to a number having two decimal places. Similarly, enumerators or other simplifications may be used. Converter 545 converts in the other direction (i.e. from simplified or restricted data types to complex ones used in the XML). The code or procedures within these APIs may be generated from the properties of data and regenerated or updated whenever those properties change.

SDO API 550 (which in this example is Java) creates the SDO (in binary form) and completes the data arrangement. The SDO may be used by storing on disc 552 (any type), hard drive 554 (e.g. RAID, HDD, SSD or hybrid), in volatile or persistent memory 556. Furthermore, the arranged data (as SDO) may be transmitted or communicated over a network 555 or communications system or by another mechanism.

The lower line of figure six provides an overview of the process starting with XML 590 as an input/output on the left. Full CDO API 560 includes optional rules for getters, setters, validation and transformations and may be implementation or data format specific. The two APIs 540 and 545 are identical for getters (570) as they convert to and from the same formats or arrangements of data. The full SDO API 580 may be used for getters only and provides an interface with the arranged or compacted data so that these data may be processed as required.

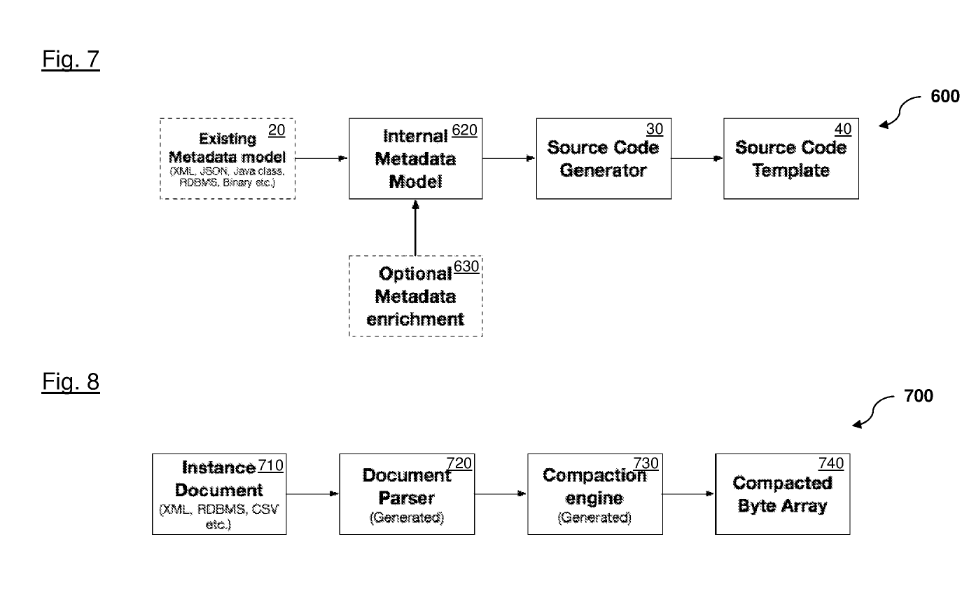

FIG. 7 shows schematically a further example process 600 of generating executable code. The features shown with dotted lines are optional. In this example, an internal metadata model 620 (and optional existing metadata model and metadata enrichment 630) provide the input to the source code generator and source code template 40.

Metadata models may be imported electronically (e.g. using XML schema, JSON schema, RDBMS, Java classes, COBOL Copybook, CSV etc.) or entered manually (typically binary). Once imported (if imported), then metadata 630 may provide enrichment. For example, metadata enrichment 630 may include data describing limited values, enumerations, maximum values and ranges etc. This proceeds onto the code generation and into source template.

FIG. 8 shows a flowchart of an example method 700. In this example, raw documents are converted to binary documents. The instance document 710 is parsed into a bound object by a document parser 720. This is similar to the standard binding process and it is effectively an intermediate stage. Intermediate counts of repeating elements may be held, for example. A Compaction engine 730 (also generated code) now creates the binary version of the document to form a compacted byte array 740.

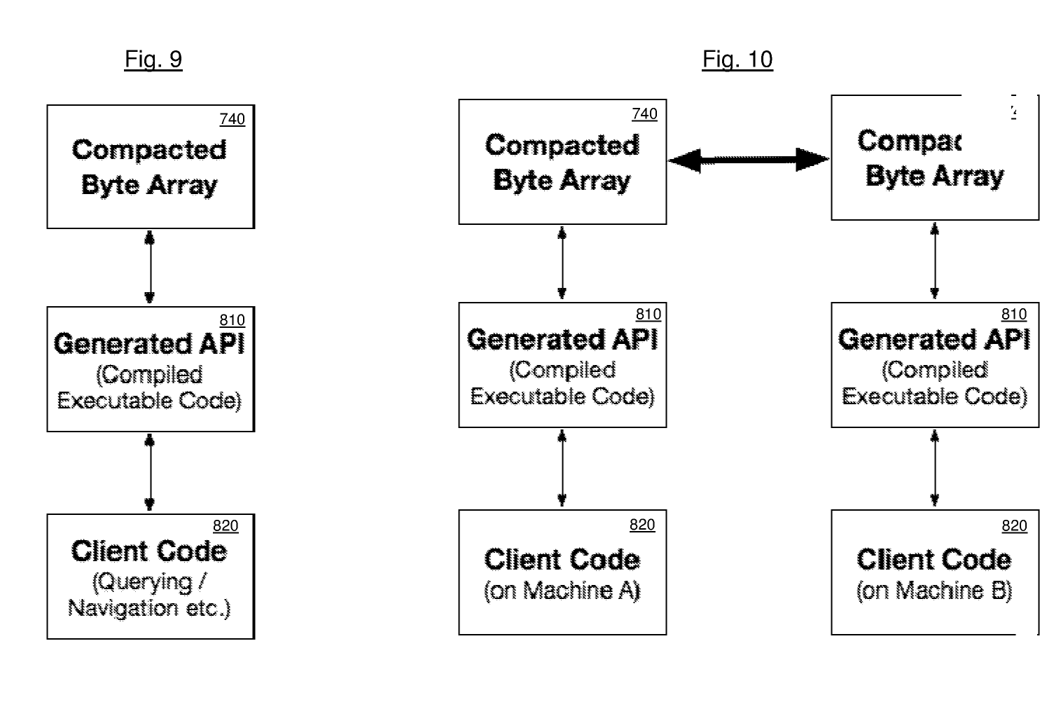

This is further illustrated schematically in FIGS. 9 and 10. During runtime use, the binary data (compacted byte array 740) may be read from memory, storage or network using the generated API 810. The client code 820 may be unaware of the binary implementation due to the object-oriented abstraction. The compacted byte array 740 is typically in an in-memory data grid (IMDG) but could also be from an RDBMS or NoSQL store, for example.

The above is an RPC example that is particularly fast. FIG. 10 illustrates an interaction between two machines. The data in machines A and B may be in separate physical locations or on the same subnet, for example. This may also be applicable for mobile phone to cloud or IoT device to server/cloud implementations. This method provides particular performance enhancements in these scenarios.

This is architecturally similar to the way CORBA works. However, the IIOP generated from the IDL needs parsing and contains metadata and so this is not as fast as the described examples and implementations.

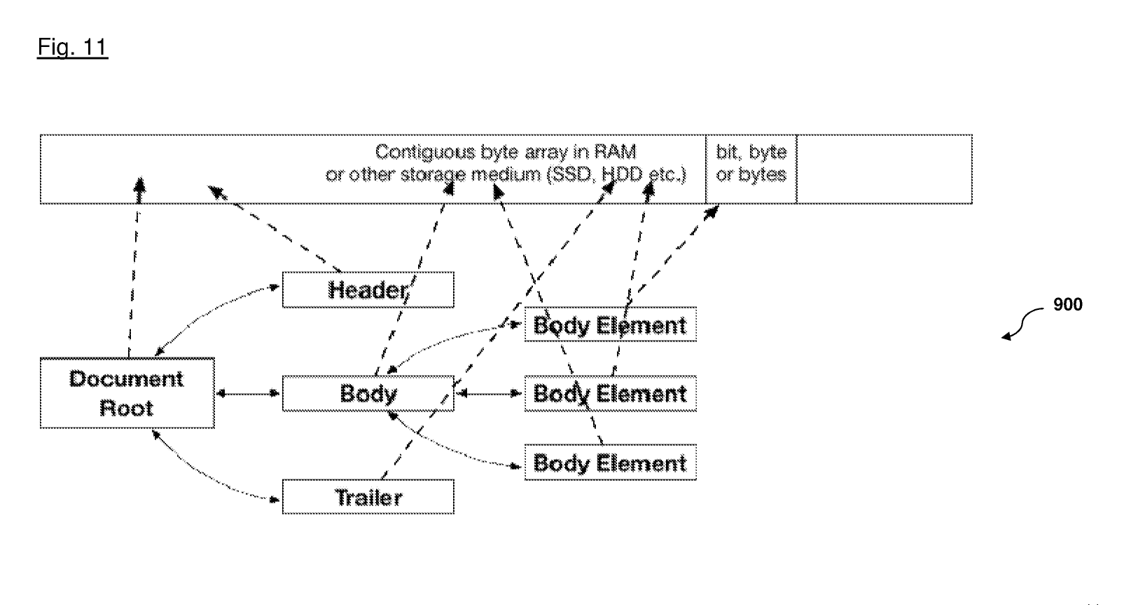

FIG. 11 shows schematically an example storage scheme 900 according to the described embodiments. Each element in FIG. 11 has its own location in memory. However, the data are not only more tightly packed and all in one place in this example but are also smaller (requiring less memory). These are not pointers but the “getter” API, e.g. getBodyElement( ) returns the uncompacted value from the byte array. The position is either generated at code generation time, calculated at runtime or a combination of both.

The following currency retrieval example (other data may be used) illustrates a method that will parse an XML document into the full Java object using the process 700 described with reference to FIG. 8.

File XML_INPUT_FILE = new File(“/valid-ird-ex01-vanilla-
swap.xml”);
Fpmlmain54DocumentRoot complexDataObject =
C24.parse(Fpmlmain54DocumentRoot.class).from(XML_INPUT_FILE);

This is compacted:

SimpleDataObject simpleDataObject=C24.toSdo(complexDataObject);

Access the raw data array may be achieved by:

byte[ ] rawData=simpleDataObject.getSdoData( );

However, the conversion into the intermediate format (of a CDO) may be hidden and so the following may also be carried out effectively:

File XML_INPUT_FILE = new File(“/valid-ird-ex01-vanilla-
swap.xml”);
Fpmlmain54DocumentRoot simpleDataObject =
C24.parse(Fpmlmain54DocumentRoot.class).from(XML_INPUT_FILE);

Where Fpmlmain54DocumentRoot is the SDO or binary definition.

A user can access the content of the complex structure in both cases (CDO or SDO) in exactly the same manner, through the generated API. For example:

String bondCurrency=complexDataObject.getBond( ).getCurrency( ).getValue( );

In the case of the full Java version or other “classic” Java binding technologies this single currency may take (depending on Java versions) 48 bytes. However, in the SDO version this requires just 1 byte as a lookup into a list of all possible currencies.

As will be appreciated by the skilled person, details of the above embodiment may be varied without departing from the scope of the present invention, as defined by the appended claims.

For example, other software languages may be used including C++. Other examples of compaction or the reduction of required memory or storage include:
Variable length encoding. Where there is an indication in the indication of properties or metadata that values will only use a subset of the available range, the number of bits required may be reduced. This may be instead of using the top-bit to indicate whether there is a following byte or not. The 7 bits from each byte (excluding a continuation bit) may be concatenated to form the 2s-complement representation.
Range-based encoding. Where there is an indication in the indication of properties or metadata that values fit within a certain range (e.g. 900-907 where there are only eight possible values) then as subsequent reduction in the number of required bits may be made (in this example, the eight values may be stored using 3 bits). The model or retrieval procedure knows to add 900 to the result. A similar approach may be used to more efficiently store dates and times.
Presence bitmasks. A bitmask may be used to indicate whether or not optional fields are present (as opposed to a null byte as per Java).
Type identification. Because the type tree is fixed at deployment time, where a type contains a reference to another object, all possible types for that object may be determined. Instead of storing a full-textual name, an enumeration may be generated and stored as an ordinal.
Enum storage. Enum definition may be incorporated into the model, arrangement scheme or indication of properties of the data and only the ordinal needs to be stored.
Similar to enums, common values can be incorporated into the model and stored by ordinal. For example, with strings the length and value may be stored. Where common values are used either the ordinal or (length+max ordinal)+value may be stored; the first value read then either provides information describing the length or the ordinal.
Dynamically generated common values—contrast static analysis and model enrichment. This may use on-the-fly spotting of duplicated strings within a single message and moving the string to a dedicated part of the buffer and using a similar storage approach to common values.
Choice groups—rather than having an object reference for each possible value, the same may be done as for type identification described above.

The arranged, stored, returned and retrieved data may be of any type including financial data (e.g. trades, prices, Swift transactions, etc.), business data, scientific data or any data used within a computer system. Further data examples include MP3, GIF, video and audio codecs and other media formats.

In an example implementation Java (1.6, 1.7 and 8) may be used and this works on all versions of Linux, UNIX, Windows and OSX and any others that support Java.

The system, method and computer program also operates on mobile devices including non-Java based devices like Apple iOS. Therefore, these are not be restricted to Java. C/C++ and any other JVM language like Scala, Groovy etc. may also be used.

The data being sent to mobile devices and on the web may include JavaScript and any DSL (Domain Specific Language) for persistence into databases, disk, SSD etc. Again, the advantages are not just in memory saving.

Whilst the specific examples mention the memory being RAM, these concepts may also be used with persistent memory such as disk drives and SSDs, for example.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for arranging data comprising the steps of:
receiving a data set including one or more data elements;
generating from an indication of properties of the one or more data elements an arrangement scheme describing how to arrange the data elements;
arranging the data elements according to the arrangement scheme; and
generating a set of computer readable procedures for returning the data elements from the arranged data elements.

2. The method of claim 1, wherein the indication of properties is a data schema.

3. The method of claim 2, wherein the data schema describes the format and/or structure of the data set.

4. The method according to any previous claim further comprising the step of storing the arranged data elements.

5. The method of claim 4, wherein the data is stored as an array.

6. The method of claim 5, wherein the array is an array of bits or bytes.

7. The method according to any of claims 4 to 6, wherein the memory is persistent memory.

8. The method according to any previous claim, wherein the step of generating the arrangement scheme includes the step of determining a data allocation requirement for the data elements based on the indication of properties.

9. The method of claim 8, wherein the step of generating the arrangement scheme further comprises the step of minimising the data allocation requirement for each data element.

10. The method according to any previous claim, wherein the computer readable procedures define one or more enumerated values associated with the one or more data elements and wherein the associated data elements are returned in response to enumerated values.

11. The method according to any previous claim, wherein the computer readable procedures provide instructions for returning the data elements.

12. The method according to any previous claim, wherein the data elements are elements of XML.

13. The method according to any previous claim, wherein the computer readable procedures are compiled code.

14. The method according to any previous claim, wherein the set of computer readable procedures is in the form of an application programming interface, API.

15. A method for returning data comprising the steps of:
receiving a request to return a data element from an arrangement of data;
selecting a computer readable procedure for returning the data element from a set of computer readable procedures; and
executing the selected computer readable procedure.

16. The method of claim 15, wherein the computer readable procedures are configured to calculate a location of the requested data element within the arrangement of data.

17. A system for arranging data in comprising:
logic configured to:
receive a data set including one or more data elements;
generate from an indication of properties of the one or more data elements an arrangement scheme describing how to arrange the data elements;
arrange the data elements according to the arrangement scheme; and
generate a set of computer readable procedures for returning the data elements from the arranged data elements; and
a processor configured to execute the logic.

18. The system of claim 17 wherein the logic is further configured to:
receive a request to return a data element;
select a computer readable procedure for returning the data element from a set of computer readable procedures; and
execute the selected computer readable procedure.

19. A computer program comprising program instructions that, when executed on a computer cause the computer to perform the method of any of claims 1 to 16.

20. A computer-readable medium carrying a computer program according to claim 19.

21. A computer programmed to perform the method of any of claims 1 to 16.
